(19) United States
(12) Patent Application Publication
(10) Pub. No.: US 2013/0090152 A1
(43) Pub. Date: Apr. 11, 2013

(54) PORTABLE WIRELESS DEVICE

(71) Applicants: Yukari Yamazaki, Ishikawa (JP); Hiroyuki Uejima, Ishikawa (JP); Hiroyuki Shioya, Ishikawa (JP); Mitsuru Saitou, Toyama (JP); Kenya Nagano, Ishikawa (JP)

(72) Inventors: Yukari Yamazaki, Ishikawa (JP); Hiroyuki Uejima, Ishikawa (JP); Hiroyuki Shioya, Ishikawa (JP); Mitsuru Saitou, Toyama (JP); Kenya Nagano, Ishikawa (JP)

(73) Assignee: PANASONIC CORPORATION, Osaka (JP)

(21) Appl. No.: 13/700,227

(22) PCT Filed: Jun. 10, 2011
(86) PCT No.: PCT/JP2011/003297

§ 371 Date: Nov. 27, 2012

(30) Foreign Application Priority Data
Jun. 10, 2010 (JP) 2010-132661

(51) Int. Cl. H01Q 1/24

(52) U.S. Cl. CPC H01Q 1/243
USPC 455/575.7; 455/575.1

(57) ABSTRACT

To provide a portable wireless device in which the portability is excellent, a decrease in a size or a closed call is enabled, and a bandwidth can be increased with a reduction in an SAR value, There is employed a structure which includes a housing forming an outer packaging of the portable telephone, a circuit board provided in the housing, an antenna element provided close to one of short sides of the circuit board, and a metal plate connected to at least one of long sides of the circuit board and the antenna element side along a side wall of the housing, and in which a side of the metal plate that is not connected to the circuit board is opened.

### TECHNICAL FIELD

The present invention relates to an improvement in a specific absorption rate (SAR) characteristic while increasing a bandwidth of an antenna in a portable telephone having a small size or capable of bringing a closed calling state.

### BACKGROUND ART

In recent years, a communication terminal device such as a portable telephone having a Bar structure or a slide structure in a smaller housing size in a calling state as compared with a conventional folding portable telephone spreads in many cases. In particular, many smart phone terminals which will be a mainstream in the future have this structure.

On the other hand, a power feeding structure of an antenna is roughly divided into a balance system and an unbalance system. In the case in which a plurality of frequency bands as in a portable telephone is used, the unbalance system is generally utilized because of a broad bandwidth characteristic. By employing the unbalance system, an antenna current is also caused to strongly flow to a substrate ground, thereby ensuring a volume for an operation as the antenna to increase a bandwidth and a gain.

For example, there is known a method of utilizing a circuit board or a shield member in a housing or the like as an antenna element to operate the whole housing as an antenna, thereby dispersing an antenna current to implement a compatibility of an increase in a bandwidth and a reduction in an SAR value (for example, see Patent Documents 1 and 2). Moreover, there is also known a method of providing a ground portion and a non-ground portion on a mounting substrate and separating an antenna element or a radiation electrode disposed in the non-ground portion and the ground portion from each other with a space therebetween, thereby implementing a compatibility of an increase in a bandwidth and a reduction in an SAR value (for example, see Patent Document 3). Moreover, there is known a method of providing a slit between a power feeding point and a ground point in an element shape of PIFA (a plate-shaped inverse F antenna) to be an unbalance system and implementing an increase in a bandwidth by a structure having three elements formed therein in a thin terminal (for example, see Patent Document 4).

### PRIOR ART DOCUMENT

### Patent Document

Patent Document 1: Japanese Patent No. 3538134
Patent Document 2: Japanese Patent No. 3830773
Patent Document 3: Japanese Patent No. 4126664
Patent Document 4: JP-A-2007-123982

### SUMMARY OF THE INVENTION

### Problems to be Solved by the Invention

In the case in which an antenna of an unbalance system is mounted, however, an antenna current distribution density is increased when a housing size is reduced in respect of a property in which an antenna current also flows to a substrate ground strongly. In other words, there is a problem in that a current distribution density of a whole housing is increased and an SAR value is thus increased irrespective of an arrangement of the antenna when the housing has a smaller size. Accordingly, it is generally hard to cause an increase in a bandwidth and a reduction in an SAR value to be compatible with each other in a small-sized terminal.

With the structures disclosed in the Patent Documents 1 and 2, accordingly, an antenna current is dispersed over a whole housing. For this reason, although an advantage can be obtained in the case in which the housing is large, the structures are not suitable for a small-sized terminal. With the structure disclosed in the Patent Document 3, moreover, a space portion is ensured. This is equivalent to an increase in a size of a housing and it is impossible to avoid the increase in the size of the housing.

With the structure disclosed in the Patent Document 4, furthermore, an element shape of PIFA is designed to reduce an antenna current flowing to a substrate ground, thereby relieving a manual influence. However, this simply changes a ratio of the antenna current distributed to the substrate ground and an antenna element to concentrate on the antenna element. In the case in which this is implemented by a small-sized terminal, a head portion and the antenna element are always close each other irrespective of an arrangement of the antenna element. For this reason, there is a fear that an SAR value might be increased.

The invention has been made in consideration of the conventional circumstances and has an object to provide a portable telephone in which an SAR characteristic can be improved and a bandwidth of an antenna can be increased, and furthermore, a size can be reduced or a closed calling state can be brought.

### Means for Solving the Problem

A Portable wireless device according to the invention includes a housing forming an outer packaging of a portable telephone, a circuit board provided in the housing, an antenna element provided close to one of short sides of the circuit board, and a metal plate connected to at least one of long sides of the circuit board and the same surface side as the antenna element along a side wall of the housing, and a side of the metal plate which is not connected to the board is opened.

According to the structure, in a small-sized terminal having an excellent portability, it is possible to increase a bandwidth while improving an SAR characteristic without increasing a size of the housing.

Moreover, a length of the metal plate is set to be equal to or more than approximately 25% of a length of the long side of the circuit board.

According to the structure, it is possible to obtain an almost equivalent advantage to that in the case in which the metal plate is provided over the whole long side of the circuit board.

Furthermore, a plurality of points is provided at an interval which is less than approximately λ/4 in order to connect the metal plate to the circuit board.

According to the structure, it is possible to obtain an almost equivalent advantage to that in the case in which grounds of the metal plate and the circuit board are soldered in a planar shape by a simple connecting method.

In addition, an electrical length of the antenna element is equal to or less than approximately (⅝)λ.

According to the structure, it is possible to increase the bandwidth while improving the SAR characteristic.

Moreover, the antenna element corresponds to two frequency bands or more.

According to the structure, it is possible to cause the improvement in the SAR characteristic and the increase in the bandwidth to be compatible with each other.

Furthermore, a fractional bandwidth of the antenna element is equal to or more than approximately 5%.

According to the structure, it is possible to cause the improvement in the SAR characteristic and the increase in the bandwidth to be compatible with each other.

In addition, a structure of the antenna element is set to be PIFA.

According to the structure, it is possible to cause the improvement in the SAR characteristic and the increase in the bandwidth to be compatible with each other.

### ADVANTAGE OF THE INVENTION

According to the invention, a portability is excellent, a reduction in a size or a closed call is enabled, and an increase in a bandwidth with a decrease in an SAR value can be carried out.

### BRIEF DESCRIPTION OF THE DRAWINGS

FIG. 1 is a view showing a Portable wireless device according to an embodiment of the invention.

FIG. 2(a) is a perspective view showing a basic structure according to the embodiment of the invention, FIG. 2(b) is a side view showing a short side, illustrating the basic structure according to the embodiment of the invention, and FIG. 2(c) is a side view showing a long side, illustrating the basic structure according to the embodiment of the invention.

FIG. 3 is a view showing an example of a distance between a metal plate and an electronic component in the basic structure according to the embodiment of the invention.

FIG. 4 is a view showing a shape in which a part on an end side of a long side of a substrate in a shield case provided on a circuit board is protruded in the basic structure according to the embodiment of the invention.

### MODE FOR CARRYING OUT THE INVENTION

An embodiment according to the invention will be described below in detail with reference to the drawings.

### First Embodiment

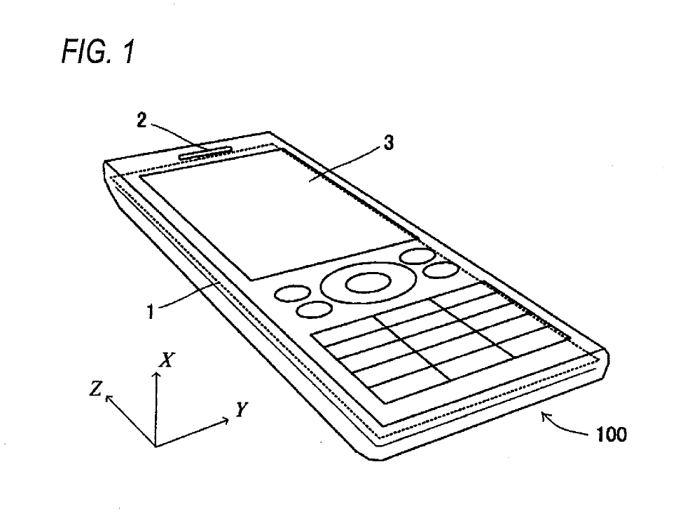

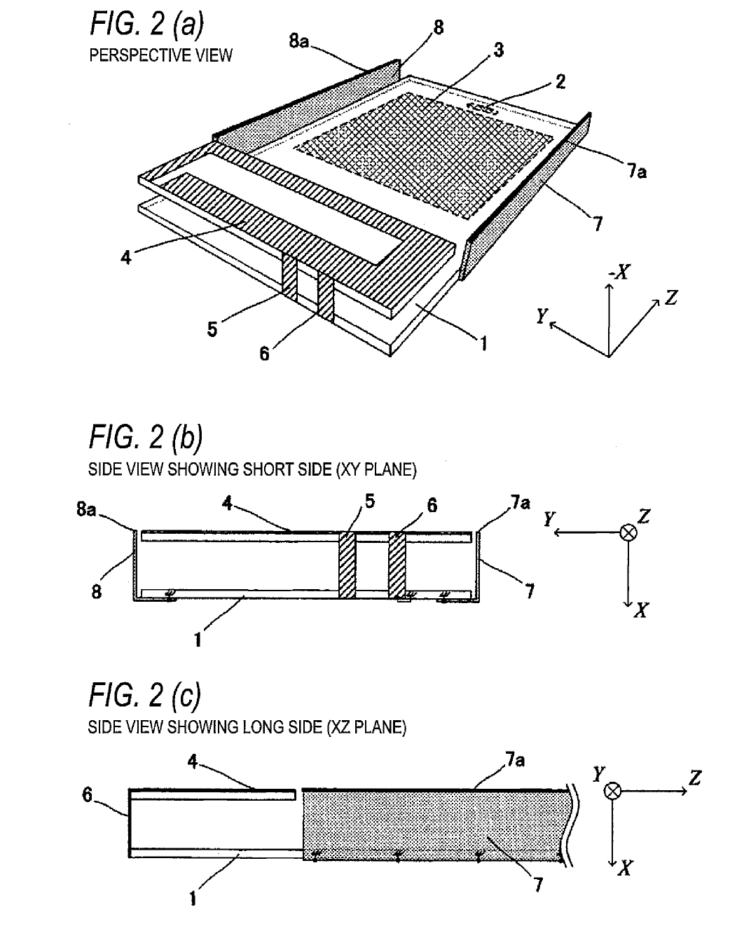

FIG. 1 shows an example of a Portable wireless device 100 according to a first embodiment of the invention, and FIG. 2 shows a basic structure according to the first embodiment of the invention, (a) being a perspective view, (b) being a side view showing a short side and (c) being a side view showing a long side.

As shown in FIGS. 2(a) to 2(c), the Portable wireless device 100 according to the embodiment has a Bar structure in which a housing size is approximately 120 mm by approximately 45 mm, and a circuit board 1, a tone hole portion 2 and a display portion 3 are provided in a housing of the Portable wireless device 100. Moreover, an antenna portion is provided on one of short sides of the circuit board 1 at a reverse side to a surface where the tone hole portion 2 is disposed.

The antenna portion is formed by an antenna element 4, a power feeding portion 5 and a short circuit portion 6 and is operated as an antenna for carrying out a communication such as a telephone or a data communication. The circuit board 1 is provided with an electronic component related to a communicating function or the like, and a ground portion is formed in at least a part through a ground pattern or the like. A power is fed to the antenna portion through the power feeding portion 5 by the circuit board 1, and the antenna portion is connected to the ground portion of the circuit board 1 through the short circuit portion 6. The tone hole portion 2 outputs various sounds and the display portion 3 carries out various displays.

Metal plates 7 and 8 are disposed on the long side of the circuit board 1 at the antenna element side in a vertical direction of the housing, and one of sides in each of the metal plates 7 and 8 is connected to the ground portion of the circuit board and an opposite side is opened. The connection of the metal plates 7 and 8 and the ground portion is carried out through soldering using a reflow method, for example.

Next, an antenna current distribution density and an SAR characteristic will be described.

In the case in which the antenna element 4 has a length of approximately λ/4, generally, a peak of an antenna current distribution is present in the vicinity of the power feeding portion 5 and an antenna current is strongly excited by the ground portion of the circuit board 1 as well as the antenna element 4 and is also emitted from the ground portion. Accordingly, the antenna current distribution density is influenced by an area of the ground portion.

In a calling state, the circuit board 1 and a head portion, particularly, a cheek are close to each other. If the circuit board 1 is smaller, therefore, the antenna current distribution density is increased more greatly so that a local SAR value tends to be greater.

In the invention, the metal plates 7 and 8 are added and one of the long sides in the metal plates 7 and 8 is connected to the ground portion to also disperse the antenna current distributed to the ground portion of the circuit board 1 into the metal plates 7 and 8, and ground ends on which the antenna current concentrates most easily, that is, metal plate open ends 7a and 8a are opened to decrease a current distribution density in a central part of the housing, thereby reducing the SAR value.

Although there is employed the structure in which the metal plates 7 and 8 are added in the embodiment, it is also possible to employ a structure in which the ground portion of the circuit board 1 is expanded. Moreover, it is also possible to utilize a metal chassis which is originally present in the Portable wireless device 100 or the like or to employ a structure in which bonding is carried out in conformity with a shape of a side wall of the housing over a flexible substrate.

Moreover, a certain advantage can be obtained if lengths of the metal plates 7 and 8 are equal to or more than 25% of a length of the ground portion of the circuit board 1. Even if the lengths are less than 25% of the length, a small advantage can be obtained.

Although there is employed the structure in which the metal plates 7 and 8 and the ground portion of the circuit board 1 are connected through soldering by using the reflow method, moreover, it is sufficient that they are electrically conducted on respective nodes also in a structure in which a contact point is provided by using a spring or a structure in which they are caused to come in contact with each other by using a screw or the like. Moreover, it is preferable that the contact points should be provided at an interval which is less than λ/4.

Moreover, it is desirable that the metal plates 7 and 8 should be disposed on both of the long sides of the circuit board 1. Even if only one of them is disposed, however, a certain advantage can be obtained.

Although the antenna element 4 has the PIFA structure with an element length of approximately λ/4, moreover, the same advantage can be obtained if there is employed a structure in which an antenna current is distributed to the ground portion, for example, a monopole antenna structure or the like. The invention is not restricted to the antenna structure according to the embodiment.

Although the tone hole portion 2 and the antenna portion are provided on opposed surfaces to each other with respect to the circuit board 1, furthermore, the same advantage can be obtained even if these are disposed on the same surface of the circuit board 1.

If the Portable wireless device 100 according to the invention is of a slide type, a folding type or a rotating type and is small-sized, a certain advantage can be obtained. Although the size is set to be approximately 120 mm by 45 mm in the embodiment, a certain advantage can be obtained even if the size is larger and a greater advantage can be obtained if the size is smaller.

### Second Embodiment

In the embodiment, there is assumed a structure in which an erected wall is separately disposed at an outside of a box-shaped shield case on a substrate.

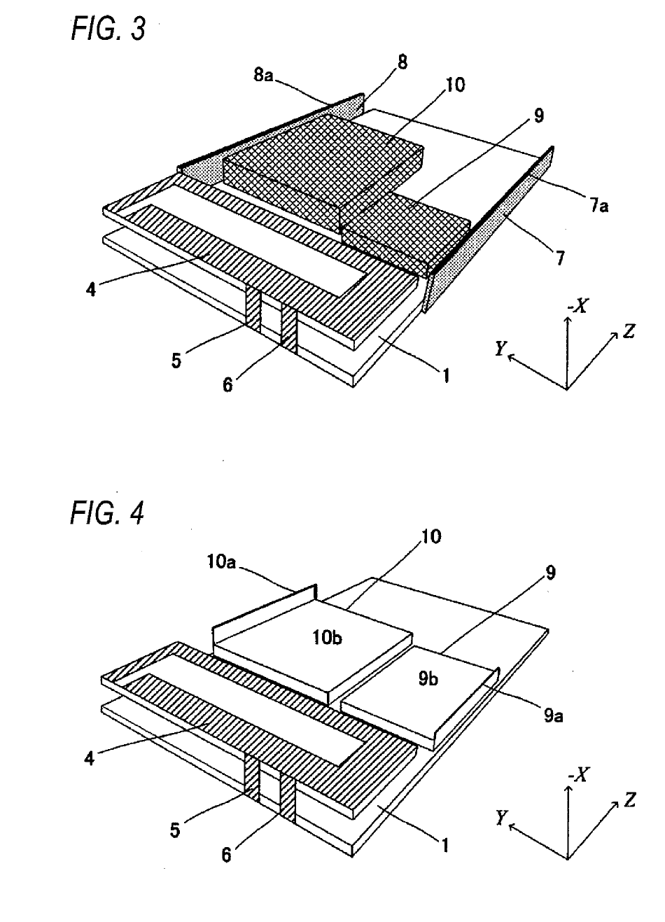

FIG. 3 is a perspective view showing a basic structure according to a second embodiment of the invention.

In FIG. 3, the same reference numerals as those shown in FIG. 2(a) denote the same components and detailed description thereof will be omitted.

In the basic structure according to the embodiment shown in FIG. 3, shield cases 9 and 10 are added to the circuit board 1 in FIG. 2(a).

The shield cases 9 and 10 are box-shaped conductive cases disposed to suppress an unnecessary radiation of a radio circuit IC related to a communicating function, a CPU for carrying out various control operations and the like, for example. The shield cases 9 and 10 are short-circuited by a ground portion of the circuit board 1, and the shield cases 9 and 10 and the ground portion are set to have the same electric potential on a high frequency basis.

An open end 7a of a metal plate and the shield case 9, and an open end 8a of a metal plate and the shield case 10 are disposed apart from each other by a distance of approximately 1 mm or more.

When the metal plate comes in contact with the shield case or when they are very close to each other, the metal plate and the shield case are connected to have the same electric potential on a high frequency basis. Therefore, one of sides of the metal plate is not opened so that an effect for dispersing an antenna current distribution cannot be obtained.

According to the structure, therefore, an antenna current is dispersed into the metal plate 7 or 8 so that an SAR value is reduced also in the case in which the shield cases 9 and 10 to be mounted on the circuit board 1 are close to the metal plates 7 and 8.

Although the shield case is employed in the embodiment, it is preferable to employ a structure in which a distance between various electronic components disposed on the circuit board such as various ICs, camera modules, micro SD card holders, batteries or the like and the metal plate is equal to or more than 1 mm.

### Third Embodiment

In the embodiment, there is assumed a structure in which a wall of a shield case is protruded at only both sides of a substrate (a wall and shield cases on both sides are shared).

FIG. 4 is a perspective view showing a basic structure according to a third embodiment of the invention.

In FIG. 4, the same reference numerals as those shown in FIG. 2(a) denote the same components and detailed description thereof will be omitted.

In the basic structure according to the embodiment shown in FIG. 4, the metal plates 7 and 8 in FIG. 3 are deleted and a surface 9a or 10a of the shield case is protruded from a surface 9b or 10b in the case in which a part of the shield case is positioned on an end at a long side of the circuit board in shield cases 9 and 10.

According to the structure, a new metal plate is not added but the shield case present originally on the circuit board is utilized to disperse an antenna current distribution, thereby enabling a reduction in an SAR value.

Although the invention has been described in detail with reference to the specific embodiments, it is apparent to the skilled in the art that various changes and modifications can be made without departing from the spirit and scope of the invention.

The application is based on Japanese Patent Application No. 2010-132661 filed on Jun. 10, 2010 and the content is incorporated herein by reference.

### INDUSTRIAL APPLICABILITY

The invention is useful as a Portable wireless device in which a portability is excellent, a decrease in a size or a closed call is enabled, and a bandwidth can be increased with a reduction in an SAR characteristic.

### EXPLANATION OF DESIGNATION

100 Portable wireless device
1 circuit board
2 tone hole portion
3 display portion
4 antenna element
5 power feeding portion
5 short circuit portion
7, 8 metal plate
7a, 8a metal plate open end
9 shield case
10 shield case
9a, 9b one surface of shield case
10a, 10b one surface of shield case

1. A portable wireless device comprising:
a housing forming an outer packaging of a portable telephone;
a circuit board provided in the housing;
an antenna element provided close to one of short sides of the circuit board; and
a metal plate connected to at least one of long sides of the circuit board and a same surface side as the antenna element along a side wall of the housing;
wherein a side of the metal plate which is not connected to the circuit board is opened.

2. The portable wireless device according to claim 1, wherein a length of the metal plate is equal to or more than approximately 25% of a length of the long side of the circuit board.

3. The portable wireless device according to claim 1, wherein a plurality of points is provided at an interval which is less than approximately λ/4 in order to connect the metal plate to the circuit board.

4. The portable wireless device according to claim 1, wherein an electrical length of the antenna element is equal to or less than approximately (⅝)λ.

5. The portable wireless device according to claim 1, wherein the antenna element corresponds to two frequency bands or more.

6. The portable wireless device according to claim 1, wherein a fractional bandwidth of the antenna element is equal to or more than approximately 5%.

7. The portable wireless device according to claim 1, wherein a structure of the antenna element is PIFA (inverse F antenna).

8. The portable wireless device according to claim 1, wherein a size in a calling state is equal to or less than 120 by 45 mm.
